(19) United States
(12) Patent Application Publication
(10) Pub. No.: US 2025/0178058 A1
(43) Pub. Date: Jun. 5, 2025

(54) PRESSING MACHINE AND PRESSING METHOD

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP); Harutaka ODA, Toyota-shi (JP)

(73) Assignee: TOYOTA BOSHOKU KABUSHIKI KAISHA, Aichi-ken (JP)

(21) Appl. No.: 18/955,482

(22) Filed: Nov. 21, 2024

(30) Foreign Application Priority Data
Nov. 30, 2023 (JP) 2023-202967

(51) Int. Cl. B21D 22/02; H01M 8/0202

(52) U.S. Cl. CPC B21D 22/02; H01M 8/0202

(57) ABSTRACT

A pressing machine includes a fixed die, a movable die, and multiple punching units. The punching units include a first punching unit and a second punching unit. The first punching unit punches a first region of a material, thereby forming a first section of a separator. The second punching unit punches a second region of the material, thereby forming a second section of the separator. The pressing machine is configured such that the first punching unit punches the first region of the material at the time of die closing, and that the second punching unit punches the second region of the material at the time of subsequent die closing.

### CROSS-REFERENCE TO RELATED APPLICATIONS

This application is based upon and claims the benefit of priority from prior Japanese Patent Application No. 2023-202967, filed on Nov. 30, 2023, the entire contents of which are incorporated herein by reference.

### BACKGROUND

### 1. Field

The present disclosure relates to a pressing machine and a pressing method.

### 2. Description of Related Art

A cell stack of a fuel cell is formed by stacking single cells in the thickness direction. Each single cell is formed by sandwiching a membrane electrode gas diffusion layer assembly with separators. The separators are manufactured by, for example, a pressing machine disclosed in Japanese Laid-Open Patent Publication No. 2014-78336. The pressing machine includes a fixed die and a movable die, which are repeatedly closed and opened. A material used for forming separators is fed between the fixed die and the movable die of the pressing machine. During die closing, the pressing machine performs shape forming on a part of a separator formation area of the material, punches a part of the separator formation area, and separates a separator from the material.

Sections of a separator that are formed by punching the material at the time of die closing include sections that need to be formed with high precision and sections that do not need to be formed with high precision. For example, in some cases, a first section of a separator is formed by punching a first region of the material, and a second section of the separator, which needs to be formed with higher precision than the first section, is formed by punching a second region of the material.

In this case, when the first region and the second region are respectively punched at the time of one die closing action, the following occurs. After the first region and the second region of the material are punched, the material may experience shrinkage due to press-induced deformation. The shrinkage affects the periphery of the second region of the material, in other words, the second section of the separator. As a result, it becomes difficult to maintain the high precision required for forming the second section of the separator.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a pressing machine includes a fixed die and a movable die configured to be repeatedly closed and opened, and multiple punching units provided at a location at which the fixed die and the movable die face each other. The pressing machine is configured to, when forming a separator for a fuel cell from a material through press working based on repetition of die closing and die opening, punch a part of the material with the punching units during the die closing. The punching units include a first punching unit and a second punching unit. The first punching unit punches a first region of the material, thereby forming a first section of the separator. The second punching unit punches a second region of the material different from the first region, thereby forming a second section of the separator, the second section being required to be formed with higher precision than the first section. The pressing machine is configured such that the first punching unit punches the first region of the material at a time of die closing, and that the second punching unit punches the second region of the material at a time of subsequent die closing.

In another general aspect, a pressing method is provided that forms a separator for a fuel cell from a material through press working based on repetition of die closing and die opening of a fixed die and a movable die, through punching a part of the material with multiple punching units provided at a location at which the fixed die and the movable die face each other during the die closing. The punching units include a first punching unit and a second punching unit. The first punching unit punches a first region of the material, thereby forming a first section of the separator. The second punching unit punches a second region of the material different from the first region, thereby forming a second section of the separator, the second section being required to be formed with higher precision than the first section. The pressing method includes using the first punching unit to punch the first region of the material at a time of die closing, and using the second punching unit to punch the second region of the material at a time of subsequent die closing.

Other features and aspects will be apparent from the following detailed description, the drawings, and the claims.

### BRIEF DESCRIPTION OF THE DRAWINGS

FIG. 1 is an exploded perspective view of a single cell.

FIG. 2 is a front view showing a separator in the single cell shown in FIG. 1.

FIG. 3 is a side view schematically showing a pressing machine for manufacturing the separator shown in FIG. 2.

FIG. 4 is a plan view schematically showing a first punching unit, a second punching unit, and a separating unit in the pressing machine shown in FIG. 3.

FIG. 5 is an enlarged cross-sectional view showing punches of the first punching unit shown in FIG. 4.

FIG. 6 is an enlarged cross-sectional view showing punches of the second punching unit and a punch of the separating unit shown in FIG. 4.

FIG. 7 is a cross-sectional view showing punches of a first punching unit according to a second embodiment.

FIG. 8 is a cross-sectional view showing punches of a second punching unit and a punch of a separating unit according to the second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

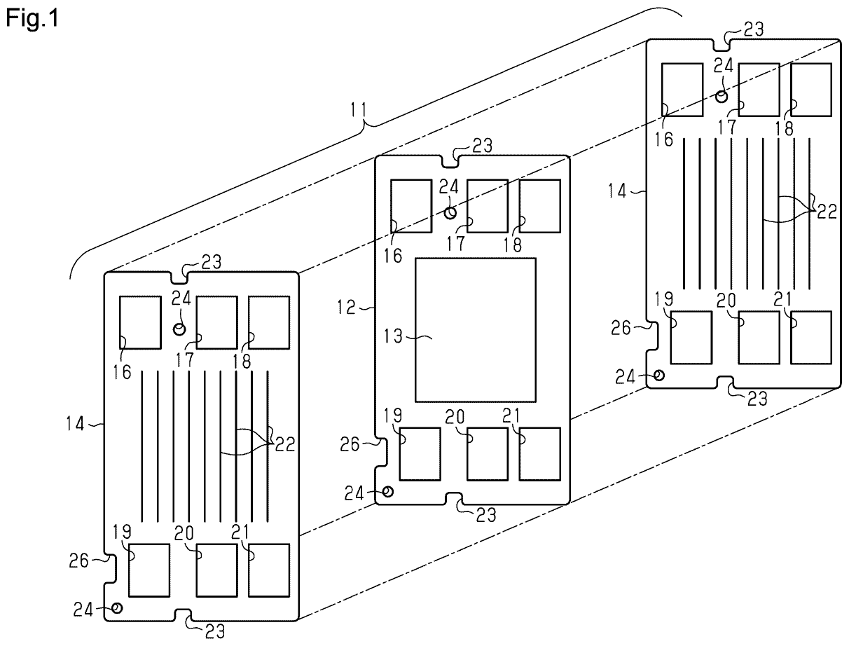

A pressing machine and a pressing method according to a first embodiment will now be described with reference to FIGS. 1 to 6.

FIG. 1 shows a single cell 11 used to form a cell stack of a fuel cell. The single cell 11 includes a plastic plate 12, a membrane electrode gas diffusion layer assembly 13, and separators 14. The plastic plate 12 is formed to have the shape of a rectangular frame. The outer edge of the membrane electrode gas diffusion layer assembly 13 is joined to the plastic plate 12. The plastic plate 12 and the membrane electrode gas diffusion layer assembly 13 are sandwiched by the separators 14 from the opposite sides in the thickness direction.

The cell stack of the fuel cell is formed by stacking single cells 11 in the thickness direction. Holes 16 to 21 are formed in the plastic plate 12 and the two separators 14 of each single cell 11. The holes 16 to 21 are positioned in opposite end portions in the long-side direction of the single cell 11. The holes 16 to 21 form passages through which fluids such as a fuel gas (hydrogen or the like), an oxidation gas (air or the like), and a coolant (cooling water or the like) flow into the cell stack or flow out of the cell stack.

The fuel gas and the oxidation gas flowing into the cell stack of each single cell 11 are supplied to the anode side and the cathode side of the membrane electrode gas diffusion layer assembly 13, so that power is generated based on the reaction between the fuel gas and the oxidation gas in the membrane electrode gas diffusion layer assembly 13. The fuel gas and the oxidation gas that have passed through the membrane electrode gas diffusion layer assembly 13 flow out from the cell stack as described above. The coolant that has flowed into the cell stack flows between the separators 14 of any two of single cells 11 that are adjacent to each other. As a result, the cell stack is cooled.

### Details of Separator 14

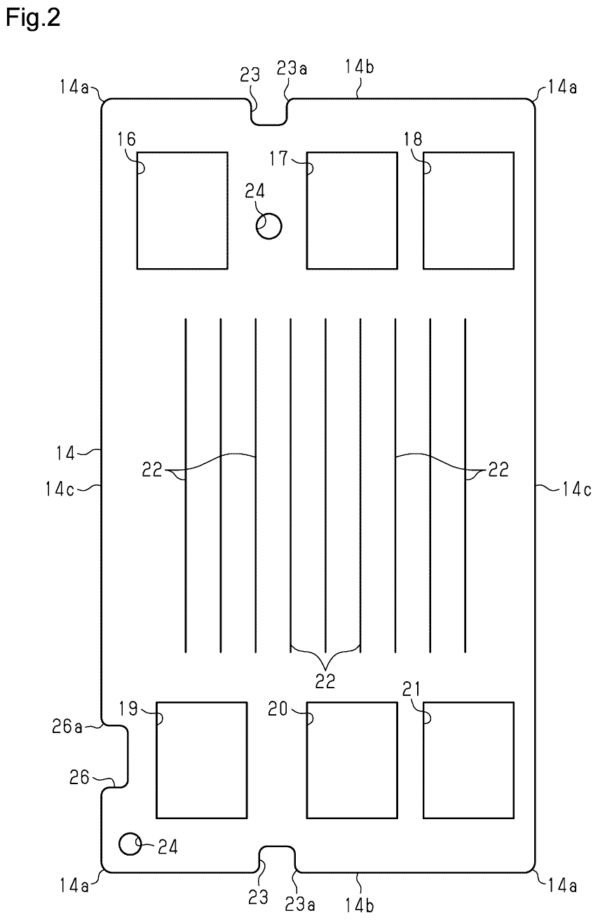

As shown in FIG. 2, the separator 14 has a rectangular shape. The holes 16 to 21 are formed in the opposite end portions of the separator 14 in the long-side direction. Multiple grooves 22 are formed in a central portion of the separator 14 in the long-side direction so as to extend in the long-side direction of the separator 14. The grooves 22 are used to supply fuel gas to the anode side of the membrane electrode gas diffusion layer assembly 13 or to supply the oxidation gas to the cathode side of the membrane electrode gas diffusion layer assembly 13.

Four corners 14a of the separator 14 are rounded and continuous with the outer peripheral surface of the separators 14. The separator 14 includes recesses 23 at the opposite ends in the long-side direction. The recesses 23 are recessed inward from short sides 14b of the outer peripheral surface of the separator 14. Each recess 23 has opening edge portions 23a that define an opening in the short side 14b. Each opening edge portion 23a is rounded and is continuous with the short side 14b. Each short side 14b of the outer peripheral surface of the separator 14 serves as a first section, and each recess 23 serves as a second section, which needs to be formed with higher precision than the first section.

The separator 14 has reference holes 24 in the opposite end portions in the long-side direction. The separator 14 has a terminal portion 26, which is recessed inward from a long side 14c of the outer peripheral surface. The terminal portion 26 has opening edge portions 26a that define an opening in the long side 14c. Each opening edge portion 26a is rounded and is continuous with the long side 14c. As shown in FIG. 1, the plastic plate 12 also has recesses 23, reference holes 24, and a terminal portion 26 at positions corresponding to the recesses 23, the reference holes 24, and the terminal portion 26 of the separators 14.

In the separator 14, the holes 16 to 21 are also included in the above-described first sections. In the separator 14, the reference holes 24 and the terminal portion 26 are included in the above-described second sections.

### Reference Holes 24, Recesses 23, and Terminal Portion 26

The reference holes 24 of the separators 14 and the plastic plate 12 are used to set the relative positions of the separators 14, the plastic plate 12, and the membrane electrode gas diffusion layer assembly 13 in the single cell 11 to appropriate positions. Specifically, when the single cell 11 is manufactured, the plastic plate 12 and the membrane electrode gas diffusion layer assembly 13 are sandwiched by the separators 14 from the opposite sides in the thickness direction in a state in which positioning pins are inserted into the reference holes 24 of the separators 14 and the plastic plate 12. Further, the separators 14, which are on the opposite sides in the thickness direction of the membrane electrode gas diffusion layer assembly 13, are joined to the plastic plate 12 while being in contact with the membrane electrode gas diffusion layer assembly 13. As a result, the single cell 11 is manufactured while the relative positions of the separators 14, the plastic plate 12, and the membrane electrode gas diffusion layer assembly 13 are set to appropriate positions.

The recesses 23 of the separators 14 and the plastic plates 12 are used to prevent misalignment of the stacked single cells 11 when the single cells 11 are stacked in the thickness direction to form a cell stack. Specifically, the single cells 11 are stacked such that positioning rails pass through the recesses 23 of the single cells 11. Accordingly, the cell stack is formed without misalignment of the single cells 11. The opening edge portions 23a of the recesses 23 in each single cell 11 are rounded to allow the above-mentioned positioning rails to be smoothly inserted into the recesses 23.

A rail-shaped terminal for extracting power from the cell stack is passed through the terminal portions 26 of the separators 14 and the plastic plates 12. This terminal is insulated from the separators 14 of the single cells 11, and is electrically connected to the membrane electrode gas diffusion layer assembly 13 via electric circuits formed on the plastic plates 12 of the single cells 11. The opening edge portions 26a of the terminal portion 26 in each single cell 11 are rounded to allow the above-mentioned rail to be smoothly inserted into the terminal portion 26.

The recesses 23, the reference holes 24, and the terminal portion 26 need to be formed with high precision, as can be seen from the respective roles described above.

### Pressing Machine

Next, the pressing machine for manufacturing the separator 14 will be described.

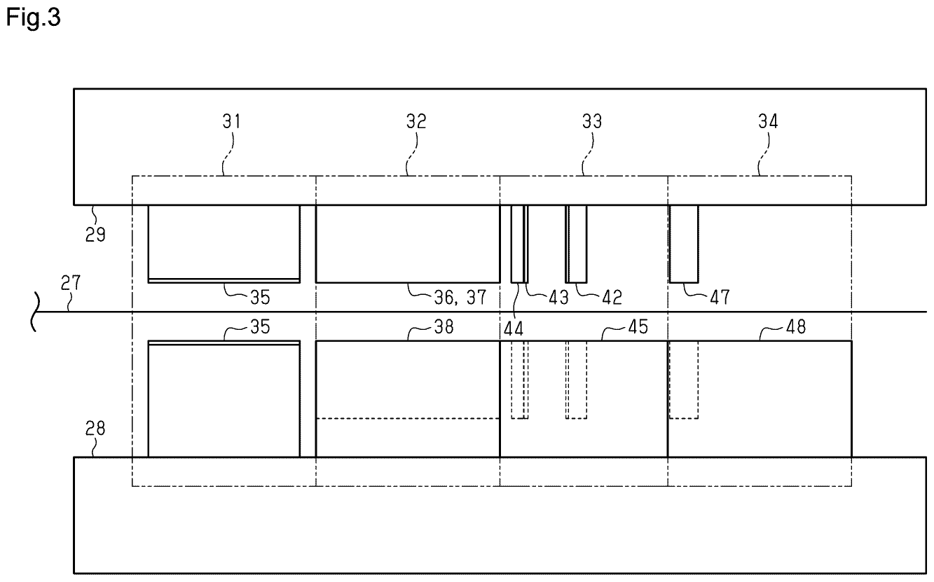

The pressing machine shown in FIG. 3 performs progressive press working on a material 27 used to form the separators 14. The separators 14 are manufactured through this progressive press working process. The pressing machine includes a fixed die 28 and a movable die 29, which are repeatedly closed and opened. The pressing machine moves the movable die 29 away from the fixed die 28 at the time of die opening, and moves the movable die 29 toward the fixed die 28 at the time of die closing.

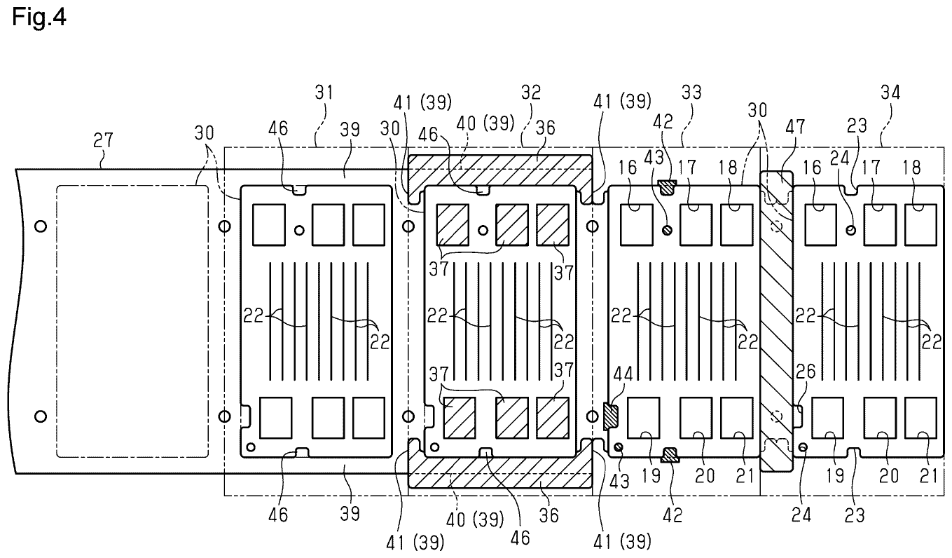

As shown in FIG. 4, the material 27 has the shape of a band. The material 27 includes rectangular forming areas 30, from which the separators 14 are to be formed. The forming areas 30 are arranged along the longitudinal direction of the material 27. As shown in FIG. 3, the material 27 is arranged between the fixed die 28 and the movable die 29 of the pressing machine. The material 27 is fed in the longitudinal direction of the material 27 toward the right side of FIGS. 3 and 4, at a pitch corresponding to the distance between adjacent ones of the forming areas 30 in the material 27, at each die opening when the fixed die 28 and the movable die 29 are repeatedly opened and closed.

The pressing machine includes a forming unit 31, a first punching unit 32, a second punching unit 33, and a separating unit 34, which are provided at a location at which the fixed die 28 and the movable die 29 face each other. Specifically, the forming unit 31, the first punching unit 32, the second punching unit 33, and the separating unit 34 are arranged in that order from the upstream side to the downstream side in the feed direction of the material 27 in the pressing machine, that is, from the left side to the right side in FIGS. 3 and 4, at the location at which the fixed die 28 and the movable die 29 face each other. The forming unit 31, the first punching unit 32, the second punching unit 33, and the separating unit 34 perform press working on the forming areas 30 of the material 27 and the periphery thereof at each die closing action. The separators 14 are formed through such press working.

Next, the forming unit 31, the first punching unit 32, the second punching unit 33, and the separating unit 34 in the pressing machine will be described individually.

### Forming Unit 31

The forming unit 31 includes forming surfaces 35. At the time of die closing, the forming surfaces 35 form, in each forming area 30 of the material 27, the grooves 22 of the separator 14, the outline of the separator 14, and the outlines of the holes 16 to 21, the recesses 23, the reference holes 24, and the terminal portion 26 of the separator 14. The forming unit 31 forms the outlines and the grooves 22 in each forming area 30 of the material 27, as shown in FIG. 4, by performing shaping on portions of the forming area 30 with the forming surfaces 35 at the time of die closing.

### First Punching Unit 32

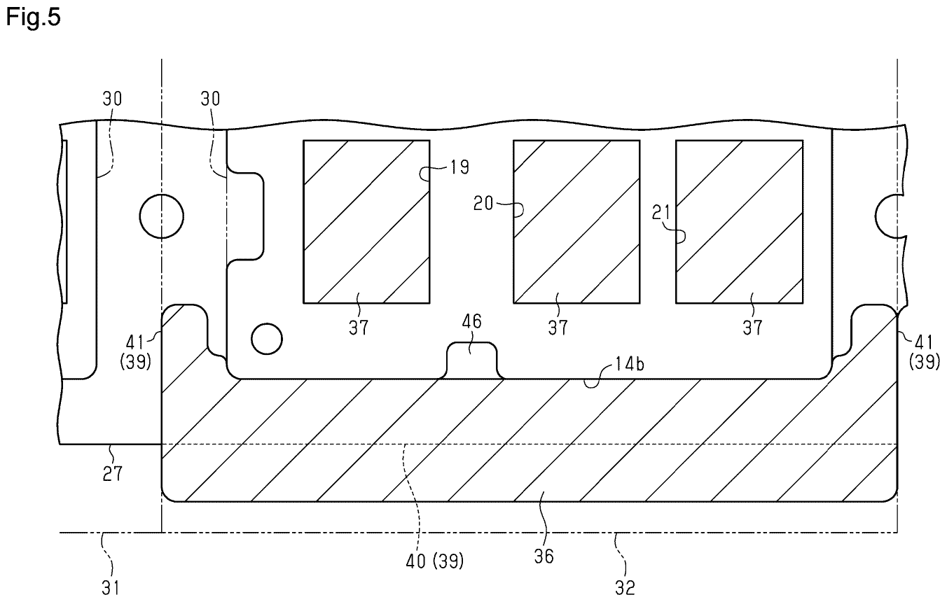

The first punching unit 32, shown in FIG. 3, includes punches 36, 37 and a die 38 for punching specified regions of the material 27 at the time of die closing. As shown in FIGS. 4 and 5, the punches 36 punch first regions 39 of the material 27. The punches 37 punch sections in each forming area 30 of the material 27 that correspond to the holes 16 to 21 of the separator 14.

The first regions 39 are located on the outer sides of the forming area 30 of the material 27, in other words, on the outer sides of the positions corresponding to the short sides 14b of the outer peripheral surface of the separator 14. The first regions 39 each have a short-side portion 40 and protruding portions 41. The short-side portion 40 is located on the outer side of the forming area 30 of the material 27 in the long-side direction, and extends in the short-side direction of the forming area 30. The protruding portions 41 extend from the opposite ends in the longitudinal direction of the short-side portion 40 toward gaps between adjacent ones of the forming areas 30. Each protruding portion 41 is spaced apart from a long side of the corresponding forming area 30.

In order to punch the first region 39 having such a shape, each punch 36 has a shape corresponding to the short-side portion 40 and the protruding portions 41 of the first region 39. As a result, each punch 36 has a shape that conforms to the position in the material 27 that corresponds to the short side 14b of the outer peripheral surface of the separator 14. At the time of die closing, the first regions 39 of the material 27 are punched by the punches 36, and regions in the forming area 30 of the material 27 that correspond to the holes 16 to 21 are punched by the punches 37, so that the first sections of the separator 14 are formed.

### Second Punching Unit 33

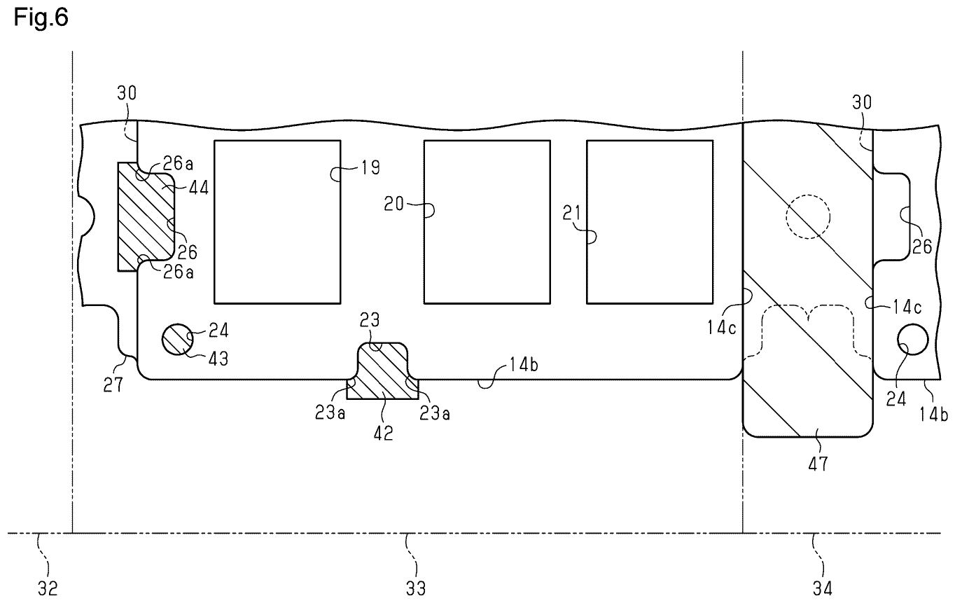

The second punching unit 33, shown in FIG. 3, includes punches 42 to 44 and a die 45 for punching specified regions of each forming area 30 of the material 27 at the time of die closing. As shown in FIGS. 4 and 6, the punches 42 punch second regions 46 located separately from the first regions 39 in the material 27. In addition, the punches 43 and the punch 44 punch, in the forming area 30 of the material 27, regions that correspond to the reference holes 24 and a region that corresponds to the terminal portion 26.

Each second region 46 is adjacent to one of the first regions 39 of the material 27, and is located on the inner side in the position of the material 27 that corresponds to the outer peripheral surface of the separator 14. Specifically, the second regions 46 are located at positions in the material 27 that correspond to the recesses 23 of the separator 14. The punches 42 for punching the second regions 46 of the material 27 each have a shape that does not overlap with the short side 14b of the outer peripheral surface of the separator 14 and corresponds to the recess 23 of the separator 14. The recesses 23 of the separator 14 are formed by punching the second regions 46 of the material 27 with the punches 42.

At the time of die closing, the punches 42 punch the second regions 46 of the material 27. Also, the punches 43, 44 punch, in the forming area 30 of the material 27, regions that correspond to the reference holes 24 and the terminal portion 26, thereby forming the second sections of the separator 14.

### Separating Unit 34

The separating unit 34 shown in FIG. 3 includes a punch 47 and a die 48 for separating each forming area 30 from the material 27 at the time of die closing to form a separator 14. As shown in FIGS. 4 and 6, the punch 47 is used to punch a portion of the material 27 that is between adjacent ones of the forming areas 30 along the long sides of the forming areas 30. The shape of the punch 47 enables such punching. The separator 14 is separated from the material 27 by punching the material 27 between adjacent ones of the forming areas 30 using the punch 47.

Operation of the pressing machine according to the present embodiment and the pressing method based on the operation will now be described.

As shown in FIG. 3, the band-shaped material 27 is arranged between the fixed die 28 and the movable die 29 of the pressing machine. At the time of die closing of the pressing machine, the forming unit 31 forms the outline of the separator 14 and the outlines of the holes 16 to 21, the recesses 23, the reference holes 24, and the terminal portion 26 are formed in the forming area 30 of the material 27, and the grooves 22 of the separator 14, as shown in FIG. 4. At the time of the subsequent die opening, the material 27 is fed toward the right side of FIGS. 3 and 4 at the above-described pitch.

At the time of the subsequent die closing of the pressing machine, the first punching unit 32 punch the short-side portions 40 and the protruding portions 41 of the first regions 39 in the material 27 with the punches 36, as shown in FIGS. 4 and 5. This forms the short sides 14b of the outer peripheral surface of the separator 14. Further, at this time, the punches 37 punch portions of the material 27 that correspond to the holes 16 to 21. This forms the holes 16 to 21 of the separator 14. At the time of the subsequent die opening, the material 27 is fed toward the right side of FIGS. 3 and 4 at the above-described pitch.

At the time of the subsequent die closing of the pressing machine, the second punching unit 33 punches the second regions 46 in the forming area 30 of the material 27 with the punches 42, as shown in FIGS. 4 and 6. This forms the recesses 23 of the separator 14. Further, at this time, the punches 43 punch portions in the forming area 30 that correspond to the reference holes 24, and the punch 44 punches a portion of the forming area 30 that corresponds to the terminal portion 26. This forms the reference holes 24 and the terminal portion 26 of the separator 14. At the time of the subsequent die opening, the material 27 is fed toward the right side of FIGS. 3 and 4 at the above-described pitch.

At the time of the subsequent die closing of the pressing machine, the separating unit 34 punches a portion of the material 27 between adjacent ones of the forming areas 30 with the punch 47, as shown in FIGS. 4 and 6. This separates a separator 14 from the material 27. In this manner, a large number of separators 14 are manufactured from the band-shaped material 27.

The present embodiment as described above has the following advantage.

(1-1) At the time of die closing of the pressing machine, the punches 36 of the first punching unit 32 punch the first regions 39 of the material 27. At the time of the subsequent die closing, the punches 42 of the second punching unit 33 punch the second regions 46 of the material 27. Specifically, the pressing machine is configured to manufacture the separators 14 by progressive press working. In the process of the progressive press working, after the first regions 39 of the material 27 are punched by the punches 36 of the first punching unit 32, the second regions 46 of the material 27 are punched by the punches 42 of the second punching unit 33.

When the first regions 39 of the material 27 are punched, press-induced deformation due to the punching and shrinkage accompanying the press-induced deformation occur in the material 27. With the above-described pressing machine, the second regions 46 of the material 27 are punched after the shrinkage of the material 27 occurs. Thus, when the recesses 23 of the separator 14 are formed by punching the second regions 46 of the material 27, the shrinkage caused by punching the first regions 39 of the material 27 does not affect the recesses 23. As described above, the shrinkage caused by the punching of the first regions 39 of the material 27 does not affect the formation of the recesses 23 in the separator 14. Thus, the recesses 23 in the separator 14 are formed with high precision.

(1-2) As shown in FIGS. 4 and 5, the first regions 39 are located on the outer side in the long-side direction of the separators 14 of the positions in the material 27 that correspond to the short sides 14b of the outer peripheral surface of the separator 14. As shown in FIGS. 4 and 6, the second regions 46 are located at positions corresponding to the recesses 23 of the separators 14, which are recessed inward from the positions of the outer peripheral surface of the separators 14 of the material 27 that correspond to the short sides 14b. As shown in FIG. 6, the opening edge portions 23a of each recess 23 of the separator 14 are rounded and continuous with the short side 14b of the outer peripheral surface of the separator 14. Therefore, the second region 46 of the material 27 shown in FIG. 5 also has a shape corresponding to the recess 23 of the separator 14.

After the punches 36 of the first punching unit 32 punch the first regions 39 of the material 27 to form the short sides 14b of the outer peripheral surface, which are the first sections in the separator 14, the punches 42 of the second punching unit 33 punch the second regions 46 of the material 27. The punches 42 of the second punching unit 33 each have a shape that does not overlap with the outer peripheral surface of the separator 14 in the material 27 and corresponds to the corresponding recess 23 of the separator 14. Therefore, the punches 42 punch the second regions 46 of the material 27 without overlapping with the positions in the material 27 that correspond to the short sides 14b of the outer peripheral surface of the separator 14, in other words, without overlapping with the short sides 14b of the outer peripheral surface, which are the first sections of the separator 14. This forms the recesses 23, which are the second sections of the separator 14.

Therefore, when the punches 42 of the second punching unit 33 punch the second regions 46, which have a shape corresponding to the recesses 23 having the rounded opening edge portions 23a, the punches 42 of the second punching unit 33 do not rub against the portions of the material 27 that have been punched by the punches 36 of the first punching unit 32, that is, the short sides 14b of the outer peripheral surface, which are the first sections of the separator 14. This prevents burrs or the like from forming due to the punches 42 rubbing against the short sides 14b of the outer circumferential surface.

(1-3) As shown in FIGS. 4 and 5, the first regions 39 of the material 27 each have the short-side portion 40 and the protruding portions 41. The short-side portion 40 is located on the outer side of the forming area 30 of the material 27 in the long-side direction, and extends along a position corresponding to the short side of the forming area 30. The protruding portions 41 extend from the opposite ends in the longitudinal direction of the short-side portion 40 toward gaps between adjacent ones of the forming areas 30. Each protruding portion 41 is spaced apart from a long side of the corresponding forming area 30. As shown in FIG. 3, the first punching unit 32 includes the punches 36 and the die 38 for punching the short-side portions 40 and the protruding portions 41 of the first regions 39. The punches 36 each have a shape that corresponds to the short-side portion 40 and the protruding portions 41 of the first region 39.

When the short-side portion 40 and the protruding portions 41 of the first region 39 shown in FIG. 5 are punched from the material 27 by the punch 36 and the die 38 of the first punching unit 32, the punching scrap has a shape corresponding to the first region 39. Accordingly, the scrap generated by the punching is prevented from coming off the die 38 since the portions of the scrap corresponding to the protruding portions 41 are caught by the die 38. Thus, when the first region 39 is punched from the material 27, it is not necessary to take measures against a case in which a scrap generated by the punching is separated from the die 38.

(1-4) The protruding portions 41 of the first region 39 shown in FIG. 5 are each spaced apart from the long side of the corresponding forming area 30 of the material 27. Therefore, when the first region 39 of the material 27 is punched by the punch 36 of the first punching unit 32, the material 27 protrudes outward from the long sides of the forming area 30 at positions on the long sides that correspond to the protruding portions 41. Therefore, when the four corners of the separator 14 have a rounded shape, the material 27 can be punched by the punches 36 of the first punching unit 32 along the rounded shapes, and the material 27 is prevented from being punched along the long sides of the forming area 30.

Then, after the first regions 39 are punched by the punches 36, the portions protruding from the long sides of the forming areas 30 in the material 27 are punched at the same time as the punch 47 of the separating unit 34 punches the portion of the material 27 that is between adjacent ones of the forming areas 30 along the long sides of the forming areas 30, as shown in FIG. 6. Thus, when the punch 47 of the separating unit 34 punches the portion of the material 27 that is between adjacent ones of the forming areas 30, the punch 47 of the separating unit 34 is prevented from rubbing against the punched portions in the material 27 on the long sides of the forming areas 30 in the material 27. This prevents the formation of burrs and other defects due to the punch 47 of the separating unit 34 rubbing against the punched regions of the material 27.

(1-5) The first sections of the separator 14 include not only the short sides 14b of the outer peripheral surface of the separator 14, but also the holes 16 to 21 for allowing fluid to flow. For this reason, since a large amount of the material 27 is punched by the punches 36, 37 of the first punching unit 32, the shrinkage of the material 27 due to press-induced deformation during the punching is likely to be large.

The second sections of the separator 14 include not only the recesses 23, but also the reference holes 24 and the terminal portion 26. In a case in which the number of the second sections in the separator 14 is relatively large as described above, when the punching of the material 27 by the punches 36, 37 of the first punching unit 32 and the punching of the material 27 by the punches 42 to 44 of the second punching unit 33 are performed at the same time, the following issues arise. The significant shrinkage of the material 27, as described above, affects the formation of the second sections in the material 27 by the punches 42 to 44 of the second punching unit 33.

In contrast, in the pressing machine, after the material 27 is punched by the punches 36, 37 of the first punching unit 32 shown in FIGS. 4 and 5, the material 27 is punched by the punches 42 to 44 of the second punching unit 33 shown in FIGS. 4 and 6. This suppresses the influence of the significant shrinkage of the material 27 on the formation of the second sections.

(1-6) The second punching unit 33 not only punches the second regions 46 of the material 27 with the punches 42, but also punches a region corresponding to the terminal portion 26 of the material 27 with the punch 44. The terminal portion 26 has the opening edge portions 26a defining an opening in a long side 14c of the outer peripheral surface of the separator 14. Each opening edge portion 26a of the terminal portion 26 is rounded and is continuous with the long side 14c of the outer peripheral surface. As shown in FIGS. 4 and 6, the punch 44 for punching the region of the material 27 that corresponds to the terminal portion 26 is shaped so as not to overlap with the position in the material 27 that corresponds to the long side 14c of the outer peripheral surface of the separator 14. Thus, when a portion between adjacent ones of the forming areas 30 in the material 27 is punched by the punch 47 of the separating unit 34 after the material 27 is punched by the punch 44 of the second punching unit 33, the region punched by the punch 44 of the second punching unit 33 in the material 27 is not rubbed against by the punch 47 of the separating unit 34. Accordingly, it is possible to suppress the generation of burrs or the like, which may occur when the portion of the material 27 punched by the punch 44 of the second punching unit 33 is rubbed against by the punch 47 of the separating unit 34.

### Second Embodiment

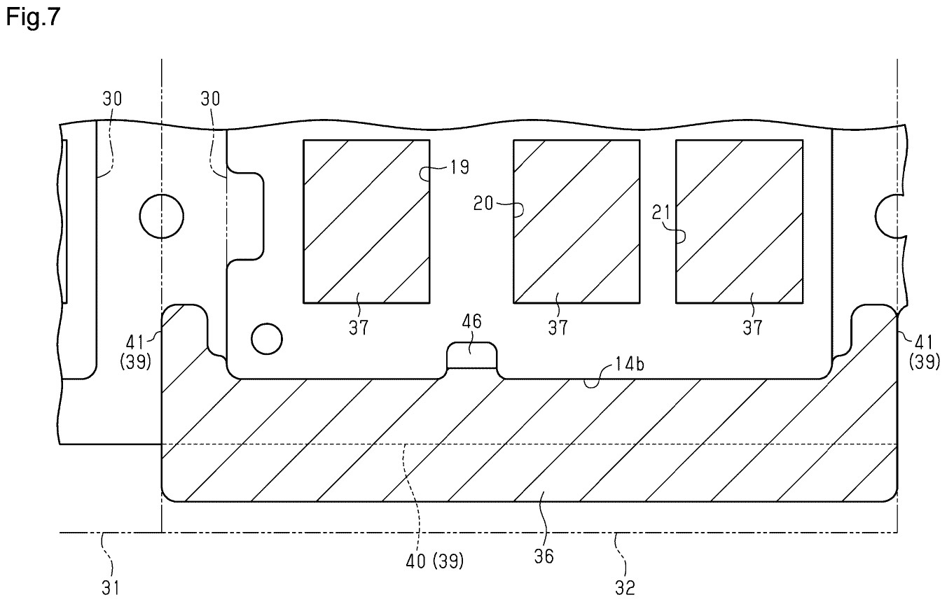

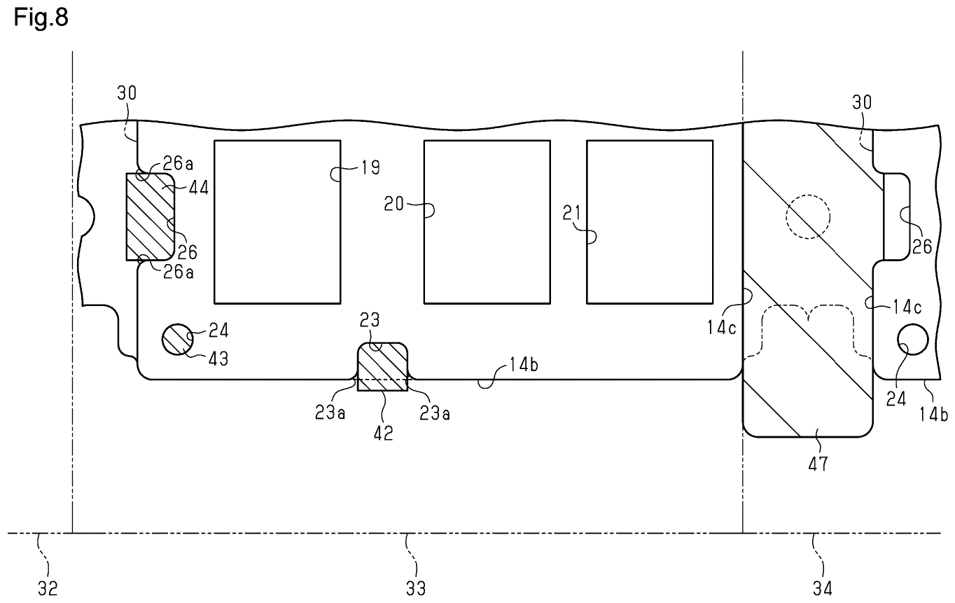

A pressing machine and a pressing method according to a second embodiment will now be described with reference to FIGS. 7 and 8.

The pressing machine of this embodiment is different from that of the first embodiment in the structure for forming the recesses 23 and the terminal portion 26 in the separator 14, in other words, the first punching unit 32, the second punching unit 33, and the separating unit 34.

The punch 36 of the first punching unit 32 has the following shape. The shape of the punch 36 is formed not only along the position in the material 27 that corresponds to the short side 14b of the outer peripheral surface of the separators 14 as shown in FIG. 7, but also along the positions that correspond to the opening edge portions 23a of the recess 23 shown in FIG. 8 of the separator 14. Therefore, the first region 39 of the material 27 in this embodiment is not only located on the outer side of the forming area 30 in the material 27, that is, on the outer side of the outer peripheral surface of the separator 14, but also located to correspond to the opening edge portions 23a of the recess 23 in the separators 14.

The shapes of the punches 42, 44 of the second punching unit 33 are as follows. As shown in FIG. 8, the punch 42 has a shape that does not overlap with the position in the material 27 that corresponds to the short side 14b of the outer peripheral surface of the separator 14 and the opening edge portions 23a of the recess 23. Further, the punch 42 has a shape corresponding to a portion of the material 27 on the inner side of the opening edge portions 23a of the recess 23 of the separator 14. Therefore, as shown in FIG. 7, the second region 46 of the material 27 in this embodiment is located on the inner side of a position that is adjacent to the first region 39 and corresponds to the outer peripheral surface of the separator 14, and located at a position on the inner side of the opening edge portions 23a of the recess 23, so as not to overlap with the opening edge portions 23a of the recess 23.

As shown in FIG. 8, the punch 44 has a shape that does not overlap with the position in the material 27 that corresponds to the long side 14c of the outer peripheral surface of the separator 14 and the opening edge portions 26a of the terminal portion 26. Further, the punch 44 has a shape corresponding to a portion of the material 27 on the inner side of the opening edge portions 26a of the terminal portion 26 of the separator 14.

The punch 47 of the separating unit 34 is configured to achieve the following when punching a portion of the material 27 between adjacent ones of the forming areas 30 along the long sides of the forming areas 30. Specifically, the punch 47 has a shape that does not overlap with a portion of the separator 14 on the inner side of the opening edge portions 26a of the terminal portion 26. Moreover, the punch 47 has a shape corresponding to the opening edge portions 26a of the terminal portion 26.

Operation of the pressing machine according to the present embodiment and the pressing method based on the operation will now be described.

At the time of die closing of the pressing machine, the first punching unit 32 punches the first regions 39 of the material 27 with the punch 36, and portions corresponding to the holes 16 to 21 of the material 27 with the punches 37, as shown in FIG. 7. Thus, the short sides 14b of the outer peripheral surface of the separator 14 are formed, and the holes 16 to 21 of the separator 14 are formed. At the time of the subsequent die opening, the material 27 is fed toward the right side of FIG. 7 at the above-described pitch.

At the time of the subsequent die closing of the pressing machine, the second punching unit 33 punches the second regions 46 in the forming area 30 of the material 27 with the punches 42 shown in FIG. 8. This forms the recesses 23 of the separator 14. Further, at this time, the punches 43 punch portions in the forming area 30 that correspond to the reference holes 24, and the punch 44 punches a portion of the forming area 30 that corresponds to the terminal portion 26. Then, the reference holes 24 of the separator 14 are formed by punching portions corresponding to the reference holes 24 in the forming area 30 with the punches 43. At the time of the subsequent die opening, the material 27 is fed toward the right side of FIG. 8 at the above-described pitch.

At the time of the subsequent die closing of the pressing machine, the separating unit 34 punches a portion of the material 27 between adjacent ones of the forming areas 30 with the punch 47 shown in FIG. 8. At this time, the punch 47 also punches a portion corresponding to the opening edge portions 26a of the terminal portion 26 in the separator 14 so as not to overlap with a portion on the inner side of the opening edge portions 26a. The terminal portion 26 of the separator 14 is formed and the separator 14 is separated from the material 27 by the punching of the material 27 by the punch 47. In this manner, a large number of separators 14 are manufactured from the band-shaped material 27.

The present embodiment described above has the following advantages in addition to the advantages (1-1), (1-3), (1-4), and (1-5) of the first embodiment.

(2-1) As shown in FIG. 7, the first region 39 is located on the outer side of the position in the material 27 that corresponds to the short side 14b of the outer peripheral surface of the separator 14 and the opening edge portions 23a of the recess 23. On the other hand, the second region 46 is located to correspond to a portion of the material 27 that is on the inner side of the opening edge portions 23a of the recess 23 of the separator 14.

The punches 36 of the first punching unit 32 punch the first regions 39 of the material 27 to form the short sides 14b of the outer peripheral surface, which are the first sections of the separator 14, and the opening edge portions 23a of the recesses 23 of the separator 14. Thereafter, the punches 42 of the second punching unit 33, shown in FIG. 8, punch the second regions 46 of the material 27 as follows. Each punch 42 punches the second portion of the material 27, which is a portion on the inner side of the opening edge portions 23a of the recess 23, without overlapping with the opening edge portions 23a of the recess 23 of the separator 14 in the material 27. This forms the recesses 23, which are the second sections of the separator 14.

Therefore, when the punches 42 of the second punching unit 33 punch the second regions 46, the punches 42 of the second punching unit 33 do not rub against the portions of the material 27 that have been punched by the punches 36 of the first punching unit 32. Specifically, the punches 42 do not rub against the short sides 14b or the opening edge portions 23a of the recesses 23 of the outer peripheral surface of the separator 14. This prevents burrs or the like from forming due to the punches 42 rubbing against the short sides 14b and the opening edge portions 23a of the recess 23 of the outer circumferential surface.

(2-2) As shown in FIG. 8, the second punching unit 33 punches not only the second regions 46 with the punches 42, but also a portion of the terminal portion 26 that is on the inner side of the opening edge portions 26a with the punch 44. The punch 44 has a shape that does not overlap with the long side 14c of the outer peripheral surface of the separator 14 or the opening edge portions 26a of the terminal portion 26 in the material 27. After the material 27 is punched by the punch 44 of the second punching unit 33, a portion of the material 27 between adjacent ones of the forming areas 30 is punched by the punch 47 of the separating unit 34 along the long sides of the forming areas 30. Also, the portions corresponding to the opening edge portions 26a of the terminal portion 26 are punched without overlapping with the portion of the terminal portion 26 on the inner side of the opening edge portions 26a. As a result, the portion of the material 27 that has been punched by the punch 44 of the second punching unit 33 is not rubbed against by the punch 47 of the separating unit 34. Accordingly, it is possible to suppress the generation of burrs or the like, which may occur when the portion of the material 27 punched by the punch 44 of the second punching unit 33 is rubbed against by the punch 47 of the separating unit 34.

### Other Embodiments

The above described embodiments may be modified as follows. The above-described embodiments and the following modifications can be combined as long as the combined modifications remain technically consistent with each other.

In the first embodiment, the opening edge portions 23a of each recess 23 in the separator 14 do not necessarily need to have rounded shapes. For example, the inner surface of each opening edge portion 23a may be orthogonal to the short side 14b of the outer peripheral surface of the separator 14.

In the first embodiment, the opening edge portions 26a of the terminal portion 26 in the separator 14 do not necessarily need to have rounded shapes. For example, the inner surface of each opening edge portion 26a may be orthogonal to the long side 14c of the outer peripheral surface of the separator 14.

In the first and the second embodiments, the four corners of the separator 14 do not necessarily need to have rounded shapes.

In the first and the second embodiments, the first regions 39 do not necessarily need to have the protruding portions 41. In this case, the punches 36 of the first punching unit 32 have a shape corresponding to the first regions 39.

Recesses such as the recesses 23 may be formed instead of the reference holes 24, and the recesses may have the function of the reference holes 24.

Punching of the material 27 by the punches 42 to 44 of the second punching unit 33 does not necessarily need to be performed at the same time of die closing. For example, the punches 42 to 44 may be distributed to multiple second punching units 33. The second punching units 33 are arranged to be adjacent to each other at intervals corresponding to the pitch in the feed direction of the material 27. In this case, as the material 27 is fed at the above-described pitch each time the dies are closed, the punches 42 to 44 punch portions of the material 27 corresponding to different forming areas 30 at each die closing.

Although the first and second embodiments illustrate a pressing machine and a pressing method that perform progressive press working, the present disclosure may also be applied to pressing machines and pressing methods that perform non-progressive press working, such as transfer press working or tandem press working. Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A pressing machine, comprising:
a fixed die and a movable die configured to be repeatedly closed and opened; and
multiple punching units provided at a location at which the fixed die and the movable die face each other, wherein
the pressing machine is configured to, when forming a separator for a fuel cell from a material through press working based on repetition of die closing and die opening, punch a part of the material with the punching units during the die closing,
the punching units include a first punching unit and a second punching unit,
the first punching unit punches a first region of the material, thereby forming a first section of the separator,
the second punching unit punches a second region of the material different from the first region, thereby forming a second section of the separator, the second section being required to be formed with higher precision than the first section, and
the pressing machine is configured such that the first punching unit punches the first region of the material at a time of die closing, and that the second punching unit punches the second region of the material at a time of subsequent die closing.

2. The pressing machine according to claim 1, wherein
the material extends between the fixed die and the movable die and has a shape of a band in which forming areas for forming the separators are arranged along a longitudinal direction,
at each die opening, the material is fed in the longitudinal direction between the fixed die and the movable die at a pitch corresponding to a distance between adjacent ones of the forming areas,
a forming unit, the first punching unit, the second punching unit, and a separating unit are provided in this order along the longitudinal direction of the material at the location at which the fixed die and the movable die face each other, and
at the die closing of the fixed die and the movable die,
the forming unit performs shape forming on a part of a corresponding forming area of the material,
the first punching unit punches the first region of the material,
the second punching unit punches the second region of the material, and
the separating unit separates a corresponding forming area from the material to form the separator.

3. The pressing machine according to claim 2, wherein
the first section of the separator includes an outer peripheral surface of the separator,
the second section of the separator includes a recess that is recessed inward from the outer peripheral surface of the separator,
the recess includes an opening edge portion defining an opening in the outer peripheral surface,
the opening edge portion has a rounded shape and is continuous with the outer peripheral surface of the separator,
the first region of the material is located on an outer side of a position in the material that corresponds to the outer peripheral surface of the separator,
the second region of the material is adjacent to the first region of the material and is located on an inner side of the position in the material that corresponds to the outer peripheral surface of the separator,
the first punching unit includes a punch for punching the first region, the punch having a shape that conforms to the position in the material that corresponds to the outer peripheral surface of the separator, and
the second punching unit includes a punch for punching the second region, the punch having a shape that does not overlap with the position in the material that corresponds to the outer peripheral surface of the separator, and the shape of the punch corresponding to the recess of the separator.

4. The pressing machine according to claim 2, wherein
the first section of the separator includes an outer peripheral surface of the separator,
the second section of the separator includes a recess that is recessed inward from the outer peripheral surface of the separator,
the recess includes an opening edge portion defining an opening in the outer peripheral surface,
the opening edge portion has a rounded shape and is continuous with the outer peripheral surface of the separator,
the first region of the material is located on an outer side of a position in the material that corresponds to the outer peripheral surface of the separator, the first region being located to correspond to the opening edge portion of the recess,
the second region of the material is adjacent to the first region of the material, and is located on an inner side of the position in the material that corresponds to the outer peripheral surface of the separator, the second region being located on an inner side of the opening edge portion of the recess so as not to overlap with the opening edge portion,
the first punching unit includes a punch for punching the first region, the punch having a shape that conforms to the position in the material that corresponds to the outer peripheral surface of the separator and the opening edge portion of the recess, and
the second punching unit includes a punch for punching the second region, the punch having a shape that does not overlap with the position in the material that corresponds to the outer peripheral surface of the separator and the opening edge portion of the recess, and the punch having a shape that corresponds to a part of the recess of the separator that is on an inner side of the opening edge portion.

5. The pressing machine according to claim 3, wherein
the separator has a shape of a rectangular plate with four rounded corners,
the first section of the separator includes a short side of the outer peripheral surface of the separator,
the second section of the separator includes the recess recessed inward from the short side of the outer peripheral surface,
the forming areas each have a rectangular shape corresponding to the separator and are arranged along a longitudinal direction of the material,
the first region of the material includes:
a short-side portion located on an outer side of the forming area of the material in a long-side direction, the short-side portion extending along a position corresponding to the short side; and
protruding portions extending from opposite ends in a longitudinal direction of the short-side portion toward gaps between adjacent ones of the forming areas, each protruding portion being spaced apart from the long side of the forming area,
the punch of the first punching unit has a shape that corresponds to the short-side portion and the protruding portions of the first region,
the first punching unit includes a die that corresponds to the punch, and
the separating unit includes a punch configured to punch a portion of the material between adjacent ones of the forming areas along a long side of the forming areas.

6. The pressing machine according to claim 5, wherein
the first section of the separator includes a hole for forming a passage through which a fluid flows,
the second section of the separator includes:
a reference hole that is used when the separator is incorporated into a fuel cell; and
a terminal portion that is recessed inward from a long side of the outer peripheral surface of the separator,
the first punching unit includes a punch that punches a portion that corresponds to the hole in the forming area of the material when punching the first region in the material, and
the second punching unit includes a punch that punches a portion corresponding to the reference hole and the terminal portion in the forming area of the material when punching the second region in the material.

7. The pressing machine according to claim 6, wherein
the terminal portion of the separator includes an opening edge portion defining an opening in the long side of the outer peripheral surface, the opening edge portion being rounded and continuous with the long side, and
the punch of the second punching unit, which punches a region that corresponds to the terminal portion of the material, has a shape that corresponds to the terminal portion of the separator without overlapping with a position in the material that corresponds to the long side of the outer peripheral surface of the separator.

8. The pressing machine according to claim 6, wherein
the terminal portion of the separator includes an opening edge portion defining an opening in the long side of the outer peripheral surface, the opening edge portion being rounded and continuous with the long side,
the punch of the second punching unit, which punches a region that corresponds to the terminal portion of the material, has a shape that corresponds to a portion of the terminal portion of the separator that is on an inner side of the opening edge portion without overlapping with a position in the material that corresponds to the long side of the outer peripheral surface of the separator and without overlapping with the opening edge portion of the terminal portion, and
the punch of the separating unit has a shape that punches a portion corresponding to the opening edge portion so as not to overlap with a portion on an inner side of the opening edge portion in the terminal portion of the separator when punching a portion between adjacent ones of the forming areas in the material along the long sides of the forming areas.

9. The pressing machine according to claim 4, wherein
the separator has a shape of a rectangular plate with four rounded corners,
the first section of the separator includes a short side of the outer peripheral surface of the separator,
the second section of the separator includes the recess recessed inward from the short side of the outer peripheral surface,
the forming areas each have a rectangular shape corresponding to the separator and are arranged along a longitudinal direction of the material,
the first region of the material includes:
a short-side portion located on an outer side of the forming area of the material in a long-side direction, the short-side portion extending along a position corresponding to the short side; and
protruding portions extending from opposite ends in a longitudinal direction of the short-side portion toward gaps between adjacent ones of the forming areas, each protruding portion being spaced apart from the long side of the forming area,
the punch of the first punching unit has a shape that corresponds to the short-side portion and the protruding portions of the first region,
the first punching unit includes a die that corresponds to the punch, and
the separating unit includes a punch configured to punch a portion of the material between adjacent ones of the forming areas along a long side of the forming areas.

10. The pressing machine according to claim 9, wherein
the first section of the separator includes a hole for forming a passage through which a fluid flows,
the second section of the separator includes:
a reference hole that is used when the separator is incorporated into a fuel cell; and
a terminal portion that is recessed inward from a long side of the outer peripheral surface of the separator,
the first punching unit includes a punch that punches a portion that corresponds to the hole in the forming area of the material when punching the first region in the material, and
the second punching unit includes a punch that punches a portion corresponding to the reference hole and the terminal portion in the forming area of the material when punching the second region in the material.

11. The pressing machine according to claim 10, wherein
the terminal portion of the separator includes an opening edge portion defining an opening in the long side of the outer peripheral surface, the opening edge portion being rounded and continuous with the long side, and
the punch of the second punching unit, which punches a region that corresponds to the terminal portion of the material, has a shape that corresponds to the terminal portion of the separator without overlapping with a position in the material that corresponds to the long side of the outer peripheral surface of the separator.

12. The pressing machine according to claim 10, wherein
the terminal portion of the separator includes an opening edge portion defining an opening in the long side of the outer peripheral surface, the opening edge portion being rounded and continuous with the long side,
the punch of the second punching unit, which punches a region that corresponds to the terminal portion of the material, has a shape that corresponds to a portion of the terminal portion of the separator that is on an inner side of the opening edge portion without overlapping with a position in the material that corresponds to the long side of the outer peripheral surface of the separator and without overlapping with the opening edge portion of the terminal portion, and
the punch of the separating unit has a shape that punches a portion corresponding to the opening edge portion so as not to overlap with a portion on an inner side of the opening edge portion in the terminal portion of the separator when punching a portion between adjacent ones of the forming areas in the material along the long sides of the forming areas.

13. A pressing method for forming a separator for a fuel cell from a material through press working based on repetition of die closing and die opening of a fixed die and a movable die, through punching a part of the material with multiple punching units provided at a location at which the fixed die and the movable die face each other during the die closing, wherein
the punching units include a first punching unit and a second punching unit,
the first punching unit punches a first region of the material, thereby forming a first section of the separator,
the second punching unit punches a second region of the material different from the first region, thereby forming a second section of the separator, the second section being required to be formed with higher precision than the first section, and
the pressing method comprising:
using the first punching unit to punch the first region of the material at a time of die closing, and using the second punching unit to punch the second region of the material at a time of subsequent die closing.
